(19) United States
(12) Patent Application Publication
(10) Pub. No.: US 2012/0055071 A1
(43) Pub. Date: Mar. 8, 2012

(54) FISHING APPARATUS

(76) Inventor: Donald L. Westin, Chaska, MN (US)

(21) Appl. No.: 13/225,503

(22) Filed: Sep. 5, 2011

Related U.S. Application Data
(60) Provisional application No. 61/380,091, filed on Sep. 3, 2010.

(51) Int. Cl. A01K 91/04; A01K 99/00; A01K 91/047

(52) U.S. Cl. 43/42.49; 43/43.1; 43/42.53

(57) ABSTRACT

One example embodiment includes a fishing apparatus. The fishing apparatus includes a connector and a first finger, where the first finger is connected to the connector and where the first finger is configured to connect to a first fishing lure. The fishing apparatus also includes a second finger, where the second finger is connected to the connector and where the second finger is configured to connect to a second fishing lure.

### CROSS-REFERENCE TO RELATED APPLICATIONS

This application claims the benefit of and priority to U.S. Provisional Patent Application Ser. No. 61/380,091 filed on Sep. 3, 2010, which application is incorporated herein by reference in its entirety.

### BACKGROUND OF THE INVENTION

Fishing is a sport enjoyed by many anglers throughout the world. There are many different types of fishing that an angler can try. For example, the angler can fly fish, can cast lures or can troll, or tow a lure behind a boat. Often, an angler has to guess which lure would be the best to use given the circumstances. For example, the time of day, the temperature, the water level, the season and other factors can all contribute to the current behavior of the target fish and, therefore, effect which lures would work best. While the angler can be alert to these factors and make an educated guess as to which lures will work best, it remains a guess.

Until the angler determines which lures are working best in the particular circumstances, they are often changing lures to see if a different lure is working better to catch the target fish. Consequently, many different devices have arisen that allow an angler to change lures more quickly. Often, these devices are tied to the end of a fishing line and then attached to the lure, rather than the lure being tied directly to the end of the fishing line, which allows for a quicker change of lure when desired.

Fishing lures are designed to attract fish in different ways. The size, shape, coloring and movement of the lure can all work together to attract fish. For example, the lure can be colored and sized to mimic a minnow that is currently abundant. The action of the lure needs to make the lure act like a swimming minnow. The wrong type of action can often scare the fish away, rather than attracting the fish.

However, these devices continue to suffer from a major drawback. They only allow for the attachment of one lure. That is, the angler is able to only use a single lure at a single time. The angler could use multiple fishing poles to simultaneously fish with multiple lures; however, this is illegal in many locations.

Additionally, while there is space to accommodate multiple lures, the lures would remain close to one another, preventing them from acting the way that they were intended and possibly damaging the lures. Thus, using multiple lures renders all of them ineffective. Therefore, an angler is simply wasting time and money if he/she chooses to attach multiple lures.

Accordingly, there is a need in the art for a device that would allow an angler to attach multiple lures to a single fishing line. Additionally, there is a need in the art for a device that keeps multiple lures sufficiently far apart that the lures can act independent of one another.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a fishing apparatus. The fishing apparatus includes a connector and a first finger, where the first finger is connected to the connector and where the first finger is configured to connect to a first fishing lure. The fishing apparatus also includes a second finger, where the second finger is connected to the connector and where the second finger is configured to connect to a second fishing lure.

Another example embodiment includes a method of manufacturing a fishing apparatus. The method includes providing a connector and providing a first finger, where the first finger is connected to the connector and where the first finger is configured to connect to a first fishing lure. The method also includes providing a second finger, where the second finger is connected to the connector and where the second finger is configured to connect to a second fishing lure.

Another example embodiment includes a fishing apparatus. The fishing apparatus includes a connector and a first finger; where the first finger is connected to the connector and configured to connect to a first fishing lure. The fishing apparatus also includes a second finger, where the second finger is connected to the connector, where the second finger is attached approximately perpendicular to the first finger and in the same plane as the first finger and configured to connect to a second fishing lure. The fishing apparatus further includes a third finger, where the third finger is connected to the connector, where the third finger is between the first finger and the second finger and in the same plane as the first finger and the second finger and configured to connect to a third fishing lure.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a fishing apparatus;

FIG. 2 illustrates an example of the fishing apparatus of FIG. 1 connected to a first fishing lure, a second fishing lure and a third fishing lure;

FIG. 3 is a flow chart illustrating an example of a method of manufacturing a fishing apparatus; and

FIG. 4 is a flow chart illustrating an example of a method for using a fishing apparatus.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

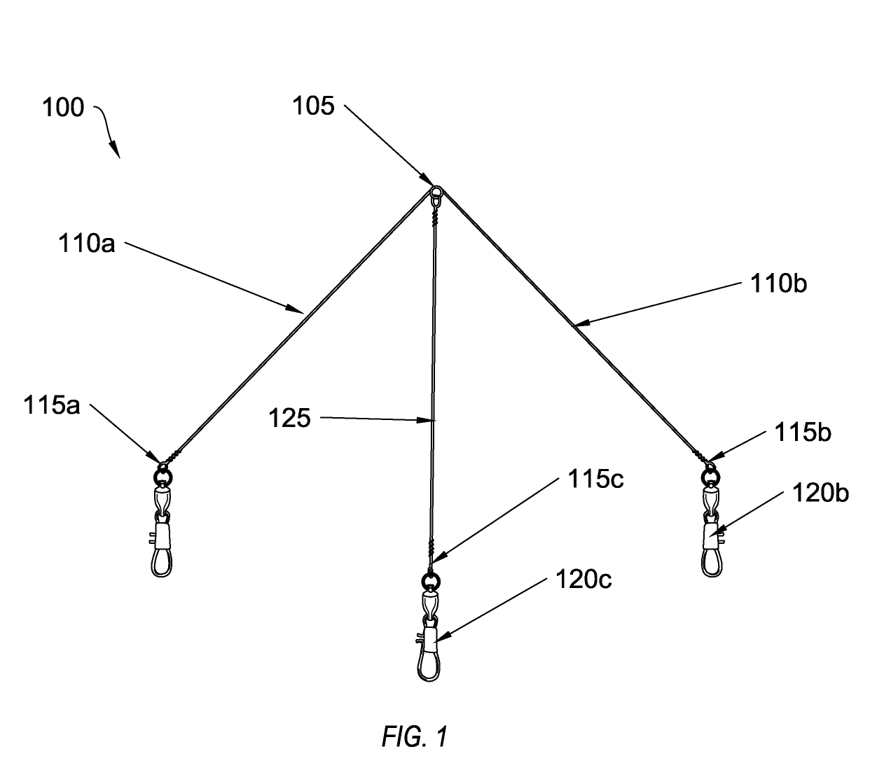

FIG. 1 illustrates an example of a fishing apparatus 100. In at least one implementation, the fishing apparatus 100 can be used to increase the amount of fishing lures used simultaneously by an angler. I.e., the fishing apparatus 100 can be used by an angler to increase the amount of fishing lures the angler has in the water, thus increasing his/her chance of catching fish. As used in the specification and the claims the term “fishing lure” shall refer to any device used to attract or catch fish, unless otherwise specified. In particular, fishing lures can include lures, hooks, bait, fishing line or any other device used to catch fish.

FIG. 1 shows that the apparatus 100 includes a first connector 105. In at least one implementation, the first connector 105 is configured to connect to a fishing line. In particular, the first connector 105 is configured to receive a fishing line to be used as an aid in fishing. The first connector 105 can include a loop of wire, a circular connector, a swivel, or any other connector that can connect the apparatus 100 to a fishing line.

FIG. 1 also shows that the apparatus 100 includes a first outside finger 110a. In at least one implementation, the first outside finger 110a can be attached to the first connector 105. One of skill in the art will appreciate that the first outside finger 110a and the first connector 105 can be made of a single piece of material. For example, the first outside finger 110a and the first connector 105 can be made of a single piece of wire. Additionally or alternatively, the first connector 105 and the first outside finger 110a can be made of different pieces of material. The first outside finger 110a can be between three and five inches long. For example, the first outside finger 110a can be approximately four inches long.

FIG. 1 shows that the first outside finger 110a includes a first attachment 115a. The first attachment 115a is configured to connect to a fishing lure or other fishing mechanism. In at least one implementation, the first attachment 115a can connect to a first swivel 120a. The first attachment 120a can include a snap ball bearing swivel or any other mechanism for connecting the fishing lure. A snap ball bearing swivel includes any fastener which can twist internally and allows the fishing lure to be placed on a “hook” which can then be closed or snapped shut.

FIG. 1 further shows that the apparatus 100 includes a second outside finger 110b. In at least one implementation, the second outside finger 110b can be attached to the first connector 105. One of skill in the art will appreciate that the second outside finger 110b, the first connector 105, and the first outside finger 110a can be made of a single piece of material. For example, the second outside finger 110b, the first outside finger 110a and the first connector 105 can be made of a single piece of wire. Additionally or alternatively, the first connector 105, the first outside finger 110a and the second outside finger 110b can be made of different pieces of material.

The second outside finger 110b can be between three and five inches long. For example, the second outside finger 110b can be approximately four inches long. In at least one implementation, the second outside finger 110b is the same length as the first outside finger 110a, to maintain the balance of the apparatus 100 while fishing, as described below. The first outside finger 110a and the second outside finger 110b can be oriented at approximately 90 degrees to one another.

FIG. 1 shows that the second outside finger 110b includes a second attachment 115b. The second attachment 115b is configured to connect to a fishing lure or other fishing mechanism. In at least one implementation, the second attachment 115b can connect to a second swivel 120b. The second attachment 115b can include a snap ball bearing swivel or any other mechanism for connecting the fishing lure. One of skill in the art will appreciate that the second attachment 115b can be the same as the first attachment 115a or can be different than the first attachment 115a without restriction, unless otherwise specified in the specification or claims.

FIG. 1 also shows that the apparatus 100 includes an inside finger 125. In at least one implementation, the inside finger 125 is in the same plane as the first outside finger 110a and second outside finger 110b and between the first outside finger 110a and the second outside finger 110b. In at least one implementation, the inside finger 125 can be the same length as the first outside finger 110a and the second outside finger 110b. One of skill in the art will appreciate, however, that the inside finger 125 can be a different length than the first outside finger 110a and second outside finger 110b without disrupting the balance of the apparatus 100, as discussed below.

FIG. 1 shows that the inside finger 125 includes a third attachment 115c. The third attachment 115c is configured to connect to a fishing lure or other fishing mechanism. In at least one implementation, the third attachment 115c can connect to a third swivel 120c. The third attachment 115c can include a snap ball bearing swivel or any other mechanism for connecting the fishing lure. One of skill in the art will appreciate that the third attachment 115c can be the same as the first attachment 115a and second attachment 115b or can be different than the first attachment 115a and second attachment 115b without restriction, unless otherwise specified in the specification or claims.

Although FIG. 1 shows the apparatus 100 with three fingers one of skill in the art will appreciate that the apparatus 100 can include more or less than three fingers. For example, the apparatus 100 could include two fingers, four fingers or any number of fingers, as desired.

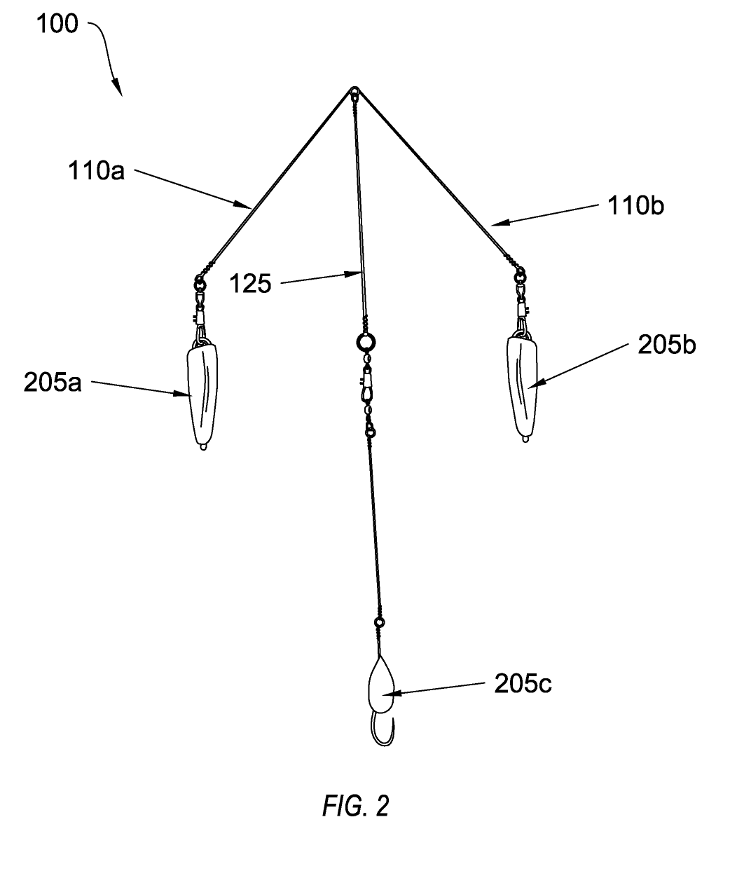

FIG. 2 illustrates an example of the apparatus 100 of FIG. 1 connected to a first fishing lure 205a, a second fishing lure 205b and a third fishing lure 205c (collectively “fishing lures 205”). In at least one implementation, the apparatus 100 can connect to multiple fishing lures 205 in order to better attract fish. The number of fishing lures 205 can match the number of fingers included in the apparatus.

FIG. 2 shows that the first fishing lure 205a is connected to the first outside finger 110a, the second fishing lure 205b is connected to the second outside finger 110b and the third fishing lure 205c is connected to the inside finger 125. In at least one implementation, the first fishing lure 205a can match the second fishing lure 205b. Matching the first fishing lure 205a with the second fishing lure 205b can ensure that the apparatus remains balanced in the water. I.e., if the first fishing lure 205a does not match the second fishing lure 205b, the apparatus 100 can twist in the water or otherwise disrupt the desired motion of the fishing lures 205.

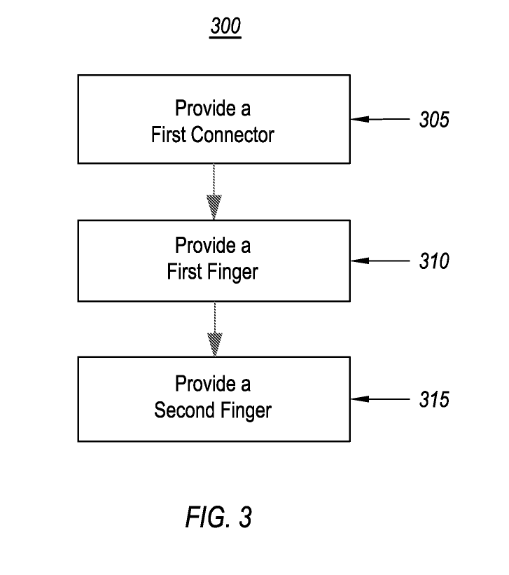

FIG. 3 is a flow chart illustrating an example of a method 300 of manufacturing a fishing apparatus. One of skill in the art will appreciate that the method 300 can be used to produce the apparatus 100 of FIG. 1; however, the method 300 can be used to produce apparatus other than the apparatus 100 of FIG. 1.

FIG. 3 shows that the method 300 includes providing a first connector 305. In at least one implementation, the first connector is configured to connect to a fishing line. In particular, the first connector is configured to receive a fishing line to be used as an aid in fishing. The first connector can include a loop of wire, a circular connector, a swivel, or any other connector that can connect the apparatus to a fishing line.

FIG. 3 also shows that the method 300 can include providing a first finger 310. In at least one implementation, the first finger can be attached to the first connector. One of skill in the art will appreciate that the first finger and the first connector can be made of a single piece of material. For example, the first finger and the first connector can be made of a single piece of wire. Additionally or alternatively, the first connector and the first finger can be made of different pieces of material. The first finger can be between three and five inches long. For example, the first finger can be approximately four inches long.

In at least one implementation, a first attachment can be attached to the first finger. The first attachment is configured to connect to a fishing lure or other fishing mechanism. In at least one implementation, the first attachment can connect to a first swivel. The first attachment can include a snap ball bearing swivel or any other mechanism for connecting the fishing lure.

FIG. 3 further shows that the method 300 includes providing a second finger 305. In at least one implementation, the second finger can be attached to the first connector. One of skill in the art will appreciate that the second finger, the first connector, and the first finger can be made of a single piece of material. For example, the second finger, the first finger and the first connector can be made of a single piece of wire. Additionally or alternatively, the first connector, the first finger and the second finger can be made of different pieces of material.

The second finger can be between three and five inches long. For example, the second finger can be approximately four inches long. In at least one implementation, the second finger is the same length as the first finger, to maintain the balance of the apparatus while fishing, as described above. The first finger and the second finger can be oriented at approximately 90 degrees to one another.

In at least one implementation, a second attachment can be attached to the second finger. The second attachment is configured to connect to a fishing lure or other fishing mechanism. In at least one implementation, the second attachment can connect to a second swivel. The second attachment 115b can include a snap ball bearing swivel or any other mechanism for connecting the fishing lure. One of skill in the art will appreciate that the second attachment can be the same as the first attachment or can be different than the first attachment without restriction, unless otherwise specified in the specification or claims.

In at least one implementation, the method 300 can further include providing a third finger. In at least one implementation, the third finger is in the same plane as the first finger and second finger and between the first finger and the second finger. In at least one implementation, the third finger can be the same length as the first finger and the second finger. One of skill in the art will appreciate, however, that the third finger can be a different length than the first finger and second finger without disrupting the balance of the apparatus, as discussed below.

In at least one implementation, the third finger can include a third attachment. The third attachment is configured to connect to a fishing lure or other fishing mechanism. In at least one implementation, the third attachment can connect to a third swivel. The third attachment can include a snap ball bearing swivel or any other mechanism for connecting the fishing lure. One of skill in the art will appreciate that the third attachment can be the same as the first attachment and second attachment or can be different than the first attachment and second attachment without restriction, unless otherwise specified in the specification or claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

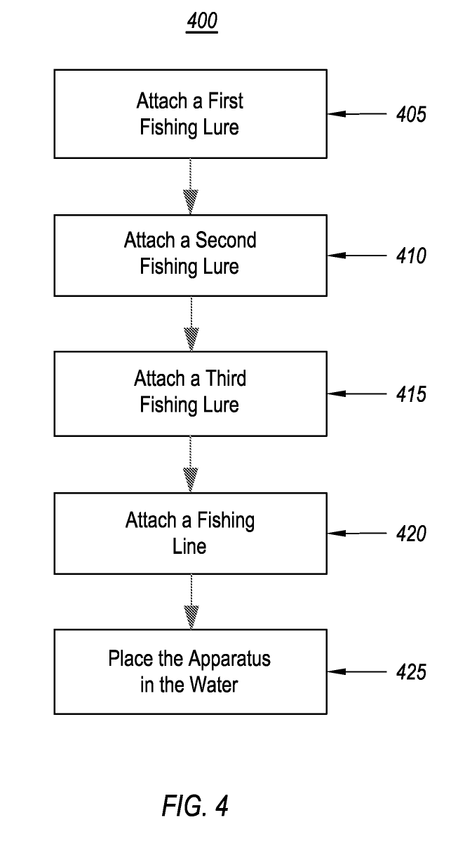

FIG. 4 is a flow chart illustrating an example of a method 400 for using a fishing apparatus. One of skill in the art will appreciate that the method 400 can be used with the apparatus 100 of FIG. 1; however, the method 400 can be used with apparatus other than the apparatus 100 of FIG. 1.

FIG. 4 shows that the method 400 includes attaching a first fishing lure 405 to the first finger, attaching a second fishing lure 410 to the second finger and attaching a third fishing lure 415 to the third finger. In at least one implementation, the first fishing lure and the second fishing lure can be the same in order to maintain the balance of the apparatus 100 while fishing, as described above.

FIG. 4 also shows that the method 400 can include attaching a fishing line 420 to the apparatus and placing the apparatus in the water 425. In at least one implementation, attaching a fishing line 420 to the apparatus can allow the angler to control the apparatus while in the water and to retrieve any fish caught. The weight of the apparatus can be configured to be approximately buoyantly neutral. I.e., the apparatus will remain at the depth that the lures and/or other attachments would attain without the apparatus present.

In at least one implementation, the method 400 can also include trolling with the apparatus. Trolling can include pulling the apparatus behind a boat or other flotation device. Trolling can cause any attached fishing lures to provide the correct “action” or produce the desired motion or behavior to attract fish.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fishing apparatus, the fishing apparatus comprising:
a connector;
a first finger, wherein the first finger is connected to the connector and wherein the first finger is configured to connect to a first fishing lure; and
a second finger, wherein the second finger is connected to the connector and wherein the second finger is configured to connect to a second fishing lure.

2. The fishing apparatus of claim 1 further comprising a fishing line attached to the connector.

3. The fishing apparatus of claim 1, wherein the connector includes a swivel.

4. The fishing apparatus of claim 1, wherein the connector includes a circular connector.

5. The fishing apparatus of claim 4, wherein the connector includes a loop of wire.

6. The fishing apparatus of claim 1, wherein the first finger is between 3 inches long and 5 inches long.

7. The fishing apparatus of claim 6, wherein the first finger is approximately 4 inches long.

8. The fishing apparatus of claim 7, wherein the second finger is between 3 inches long and 5 inches long.

9. The fishing apparatus of claim 8, wherein the second finger is approximately 4 inches long.

10. The fishing apparatus of claim 1 further comprising a third finger, wherein the third finger is connected to the connector and wherein the third finger is configured to connect to a third fishing lure.

11. A method of manufacturing a fishing apparatus, the method comprising:
providing a connector;
providing a first finger, wherein the first finger is connected to the connector and wherein the first finger is configured to connect to a first fishing lure; and
providing a second finger, wherein the second finger is connected to the connector and wherein the second finger is configured to connect to a second fishing lure.

12. The method of claim 11 further comprising a first attachment on the first finger, wherein the first attachment is configured to attach the first fishing lure to the first finger.

13. The method of claim 12 further comprising a second attachment on the second finger, wherein the second attachment is configured to attach the second fishing lure to the second finger.

14. The method of claim 12, wherein the first attachment includes a swivel.

15. The method of claim 11, wherein the swivel includes a snap ball bearing swivel.

16. A fishing apparatus, the fishing apparatus comprising:
a connector;
a first finger; wherein the first finger is:
connected to the connector; and
configured to connect to a first fishing lure;
a second finger, wherein the second finger is:
connected to the connector, wherein the second finger is attached approximately perpendicular to the first finger and in the same plane as the first finger; and
configured to connect to a second fishing lure; and
a third finger, wherein the third finger is:
connected to the connector, wherein the third finger is between the first finger and the second finger and in the same plane as the first finger and the second finger; and
configured to connect to a third fishing lure.

17. The fishing apparatus of claim 16 further comprising:
the first fishing lure connected to the first finger;
the second fishing lure connected to the second finger; and
the third fishing lure connected to the third finger.

18. The fishing apparatus of claim 16, wherein the first fishing lure matches the second fishing lure.

19. The fishing apparatus of claim 16, wherein the connector and the first finger include a single wire.

20. The fishing apparatus of claim 16, wherein the connector, the first finger and the second finger include a single wire.
